(19) United States
(12) Patent Application Publication
(10) Pub. No.: US 2024/0088689 A1
(43) Pub. Date: Mar. 14, 2024

(54) DISCHARGE DEVICE, ELECTRICALLY POWERED UNIT AND DISCHARGE METHOD

(71) Applicant: Brose Fahrzeugteile SE & Co. Kommanditgesellschaft, Würzburg, Würzburg (DE)

(72) Inventors: Michael Rök-Ramirez, Würzburg (DE); Volkmar Buckow, Eckental (DE)

(21) Appl. No.: 18/512,312

(22) Filed: Nov. 17, 2023

Related U.S. Application Data
(63) Continuation of application No. PCT/EP2022/072766, filed on Aug. 15, 2022.

(30) Foreign Application Priority Data
Aug. 17, 2021 (DE) 10 2021 209 021.4

(51) Int. Cl. H02J 7/00

(52) U.S. Cl. CPC H02J 7/0063; H02J 2207/20; H02J 2310/40

(57) ABSTRACT

A discharge device, for discharging an electrical network or an electrically operated unit, includes a discharge circuit having a discharge resistor and a normally-off first semiconductor switch connected in series with the discharge resistor. A controller controls the first semiconductor switch. The controller is commanded in such a manner that the discharge circuit is deactivated during normal operation of the electrical network or the electrically operated unit and the discharge circuit is activated in the event of commanding failing to occur. An electrically powered unit and a discharge method are also provided.

### CROSS-REFERENCE TO RELATED APPLICATION

This application is a continuation, under 35 U.S.C. § 120, of copending International Patent Application PCT/EP2022/072766, filed Aug. 15, 2022, which designated the United States; this application also claims the priority, under 35 U.S.C. § 119, of German Patent Application DE 10 2021 209 021.4, filed Aug. 17, 2021; the prior applications are herewith incorporated by reference in their entirety.

### FIELD AND BACKGROUND OF THE INVENTION

The invention relates to a discharge device or discharge arrangement for discharging an electrical system, particularly a high voltage system, or an electrically powered unit of such an electrical system. The invention furthermore relates to an electrical unit of this type having a discharge device of this type and also a discharge method.

In modern motor vehicles, components which are usually parallel to the components powered with a voltage having a voltage value of 12 V (volts), but are powered with a higher operating voltage value, are often also used. Particularly in motor vehicles with a purely electric drive or with a hybrid drive, high operating voltages of that type may exceed a value of 100 V. In that case, even voltage values of more than 60 V may be termed “high voltage (HV)” in the automotive sector. Particularly the electric units powered with high voltage, typically electric drive systems, which for example include a traction motor, a coolant or lubricant pump, a refrigerant compressor (air conditioning compressor) or the like, are in that case integrated in what is known as a “high voltage system.” A high voltage system of that type generally also includes at least one energy storage device (e.g. a capacitor) which is associated with in each case one or all electric units of the high voltage system. That is used for example to keep the operating voltage value, which is required for the electric unit or the electric units, constant.

However, for safety reasons it is necessary that high voltage systems of that type can be switched off on one hand and in particular discharged on the other hand. That is the case in particular if people may come into contact with the respective high voltage system or electrical short circuits may occur in another manner, for example during vehicle maintenance or vehicle repair or, in certain circumstances, even in the event of a vehicle accident.

In order to enable an automatic discharge of a capacitor carrying high voltage as an energy storage device for example, either a purely passive resistive method or a circuit having controlling semiconductors (semiconductor switches) can be used as a discharge device (active discharge). Resistive or passive methods typically have the disadvantage that a very high power loss is generated or that the high voltage is only lowered to a non-hazardous value after rather a long time.

In order to discharge the electric unit with a high, dangerous operating voltage it is necessary in the case of a malfunction or fault that even in the event of a failure of control elements, the voltage is reduced or discharged as fast and reliably as possible to a non-hazardous value. However, the (passive) discharge devices kept in reserve for that purpose often have a high power consumption in the rest state, in which no discharge takes place. Furthermore, discharge devices are generally dimensioned in such a manner that the power consumption thereof is still acceptable at high residual voltages, which in the case of increasing discharge—and therefore decreasing residual voltage—leads to a slowing down of the discharge rate.

### SUMMARY OF THE INVENTION

It is accordingly an object of the invention to provide a particularly suitable discharge device, electrically powered unit and discharge method, which overcome the hereinafore-mentioned disadvantages of the heretofore-known devices, units and methods of this general type. In particular, the safest possible discharge of an electrical system or an electrically powered unit of such an electrical system should be enabled. Furthermore, a highest possible discharge rate should be achieved for a simultaneously low power loss.

With the foregoing and other objects in view there is provided, in accordance with the invention, a discharge device for discharging an electrical system or an electrically powered unit, comprising:
a discharge circuit having a discharge resistor and a normally-off first semiconductor switch, which is connected in series thereto, and
a controller for activating the first semiconductor switch,
the controller being commanded in such a way that during normal operation of the electrical system or the unit, the discharge circuit is deactivated, and in the event of the absence of the commanding, the discharge circuit is activated.

With the objects of the invention in view, there is also provided an electrically powered unit, particularly an electric refrigerant compressor of a motor vehicle, having a discharge device according to the invention.

With the objects of the invention in view, there is concomitantly provided a discharge method for discharging an electrical system or an electrically powered unit by using a discharge device according to the invention, wherein the first semiconductor switch is turned on if no disable signal is supplied to the disable input.

Advantageous embodiments and developments are the subject matter of the dependent claims.

Insofar as method steps are described in the following, advantageous embodiments for the discharge device and/or the unit emerge in particular in that these are configured to execute one or more of these method steps. The conjunction “and/or” is to be understood in such a manner here and in the following that the features linked by this conjunction may be formed both together and as alternatives to one another.

The discharge device according to the invention is provided for passively discharging an electrical system or an electrically powered unit, that is to say for a passive discharge of the electrical system or the unit, and is suitable and set up for that. The electrical system is preferably a high voltage system. A high voltage system, particularly a vehicle high voltage system of a motor vehicle, is understood here and in the following to mean a (vehicle) electrical system in particular, in which voltages greater than or equal to 60 V are processed. The electrically powered unit is for example a component of such a high voltage system. For example, the unit is realized as an electrical refrigerant compressor or air conditioning compressor of the motor vehicle.

The discharge device has a discharge circuit, via which a component, which is to be discharged, of the electrical system or of the electrically powered unit is connected, particularly in a discharge mode, to a reference potential (preferably ground potential). In this case, the discharge circuit is particularly wired parallel to the component to be discharged. To this end, the discharge circuit has an (ohmic) resistor, which is termed a “current limiting resistor” or “discharge resistor” in the following, as power load and a first semiconductor switch, which is termed a “discharge switch” in the following. The discharge switch is used in this case for the in particular reversible connection of this component, which is to be discharged, to the reference potential indirectly via the discharge resistor. In other words, the discharge circuit is configured in such a manner that the high voltage system or at least the electrically powered unit (particularly at least the component to be discharged) is electrically conductively connected to the reference potential via the discharge resistor when the discharge switch is closed (that is to say enabled or turned on).

In this case, the discharge switch is realized to be normally-off, this means that the discharge switch without an activation or discharge signal is in an open or turned-off state. The discharge switch is particularly realized as a MOSFET, as an IGBT or as a SiCMOS.

In addition, the discharge device has a controller, that is to say a control unit or a control circuit, for activation, which is disposed on the gate terminal side of the discharge circuit or of the discharge switch and is preferably conductively connected to the discharge switch.

According to the invention, the controller is commanded in such a manner that during normal operation of the electrical system or the unit, the discharge circuit is deactivated, and that in the event of the absence of the commanding, the discharge circuit is activated. This means that the controller automatically or autonomously turns on the discharge switch and the discharge circuit therefore transitions from a rest mode to a discharge mode if the commanding is absent. A particularly suitable discharge device is realized as a result. The discharge device has a lower power consumption in the rest state (normal operation) in particular and is constantly active without an actuation device. The discharge current in an active discharge circuit is preferably changed as a function of the voltage of the electrical system or the unit—which decreases during the discharge.

In this case, the controller is generally set up—in terms of programming and/or circuitry—to carry out the previously described functionality according to the invention. The controller is therefore actually set up to detect the absence of commanding and to activate the discharge circuit or the semiconductor switch in the event of such an absence.

In a conceivable embodiment, the controller is, at least at its core, formed by a microcontroller with a processor and a data memory, in which the functionality for carrying out the functionality according to the invention is implemented programmatically in the form of operating software (firmware), so that the functionality is carried out automatically when the operating software is executed in the microcontroller. In the context of the invention, the controller can however alternatively also be formed by a non-programmable electronic component, such as an application specific integrated circuit (ASIC) for example, in which the functionality is implemented using circuitry measures.

In a preferred embodiment, the controller has a disable input for a disable signal. The controller monitors the disable input during operation. For example, the disable input is monitored by the controller in this case as to whether it is switched on and off at regular time intervals. The disable signal used for commanding is for example generated as an alternating signal, that is to say as an AC voltage or as a pulsed signal, by a superordinate control element (actuation device) of a vehicle electrical system. The disable signal is in this case generated by a main microcontroller for example, which realizes the actual device function of the electrical system. The main microcontroller is for example a motor control, a current monitor or a communication device and is supplied by a low voltage (for example from a 12 V vehicle electrical system).

In the case of a failure of this alternating signal or a fault in the same, according to the invention, the discharge circuit or the discharge switch is activated autonomously. This means that the controller turns on the discharge switch and the discharge circuit therefore transitions from a rest mode to a discharge mode if no disable signal is supplied to the disable input, therefore if the expected disable signal does not occur or deviates from the expected signal. A particularly suitable discharge device is realized as a result.

The discharge device is commanded in such a manner by using the disable signal that the discharge circuit is switched off in normal operation. The long-term power loss of the discharge device is reduced as a result. When the commanding ceases, the discharge circuit is automatically active. Therefore, according to the invention, a discharge arrangement is specified, which has a low power consumption in the rest state (normal operation) and is constantly active without an additional actuation device. As a result, shorter discharge times of energy storage devices are enabled at higher voltages. In particular, no software and no processor functions are therefore necessary for the correct function of the discharge device.

In an advantageous embodiment, a pulse width modulation driver (PWM driver), that is to say a driver circuit or a gate driver, is disposed between the controller and a control input of the discharge switch for the pulse-width-modulated activation of the discharge resistor. Due to the PWM activation, smaller power requirements are placed on the load resistors or on the discharge resistor.

In an expedient development, the PWM driver has an emitter circuit, which is connected to the controller, having a bipolar junction transistor and having a base series resistor connected between the base and the controller and also having a collector resistor, which is led on the emitter side to the reference potential and on the collector side to an output stage having two complementary second semiconductor switches. In this case, the emitter circuit activates the second semiconductor switches, which are preferably realized as bipolar junction transistors, on the base side. In this case, the second semiconductor switches are realized as an NPN and as a PNP transistor. Due to the complementary output stage, current amplification is realized for the activation current of the discharge switch, so that fast switching is enabled for the clocked discharge mode.

An additional or further aspect of the invention provides that the controller detects the voltage of the electrical system (system voltage) or the (operating) voltage applied at the unit or the component by using a voltage divider. In other words, the controller is coupled with a (high voltage) voltage measurement device, in order to monitor the temporal voltage curve in the course of the discharge process.

In a preferred development, the discharge current—and therefore the discharge process or discharge mode—is changed as a function of the voltage which decreases during the discharge. To this end, a pulse width of the pulse-width-modulated activation of the discharge switch is controlled as a function of the voltage detected by the controller.

In a conceivable embodiment, a voltage regulator or level converter (level shifter), which is activated by the controller, is in this case connected between the controller and the PWM driver, which voltage regulator or level converter adjusts the pulse width of the PWM activation as a function of the current voltage. The discharge device is preferably controlled in such a way that a predetermined maximum power loss is not exceeded during the discharge.

In an expedient embodiment, the PWM activation is controlled in such a manner that the pulse width is enlarged with decreasing voltage of the electrical system or the unit. This means that the discharge takes place by loading with a (discharge) resistor, which is controlled by a switch element (discharge switch), the pulse width of which increases with decreasing operating voltage. The relationship between the current voltage and the pulse width is preferably dimensioned in such a manner that for every (operating) voltage, the same power is converted on average in the discharge resistor.

In a suitable embodiment, the discharge circuit has one resistor which is connected in series to the discharge resistor and the discharge switch, wherein in the event of absence of the disable signal, an output voltage of the resistor is monitored by the controller. During an activation of the discharge due to absence of the disable signal, the output voltage at the resistor is measured, in order to determine the correct function of the discharge circuit. As a result, safeguarding of the function via controller during operation is possible. The discharge device therefore contains an output signal, using which its function can be tested at the request of a control element. As a result, the safety and reliability of the discharge device is improved further.

The electrically powered unit according to the invention is preferably part of a motor vehicle and in particular set up for high voltage operation. The electrically powered unit is therefore part of a previously described high voltage system or itself forms a high voltage system of this type. The electrically powered unit according to the invention is for example an electric refrigerant compressor of a motor vehicle, wherein the high voltage system is an intermediate circuit of the motor electronics in particular, and wherein the component part to be discharged or the component to be discharged is an intermediate circuit capacitor for example. The unit has the previously described discharge device in this case. The advantages and embodiments listed with regard to the discharge device are also analogously transferable to the unit and vice versa.

The discharge method according to the invention is used for discharging the previously described electrical (high voltage) system or the previously described electrically powered unit. The preferably passive discharge method is carried out automatically or autonomously by using the previously described discharge device. In this case, the discharge switch is turned on if no disable signal is supplied to the disable input of the controller. As a result, the component to be discharged is discharged via the discharge circuit with a high discharge rate and thus in a particularly short time. At the same time, the long-term power loss of the discharge device is reduced due to the discharge method. In other words, a loss reduction is realized with a fast passive discharge.

Other features which are considered as characteristic for the invention are set forth in the appended claims.

Although the invention is illustrated and described herein as embodied in a discharge device, an electrically powered unit and a discharge method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block circuit diagram of a discharge device for an electrically powered unit;

FIG. 2 is a schematic circuit diagram of the discharge device; and

FIG. 3 is a schematic time-voltage graph of a discharge process of the discharge device.

### DETAILED DESCRIPTION OF THE INVENTION

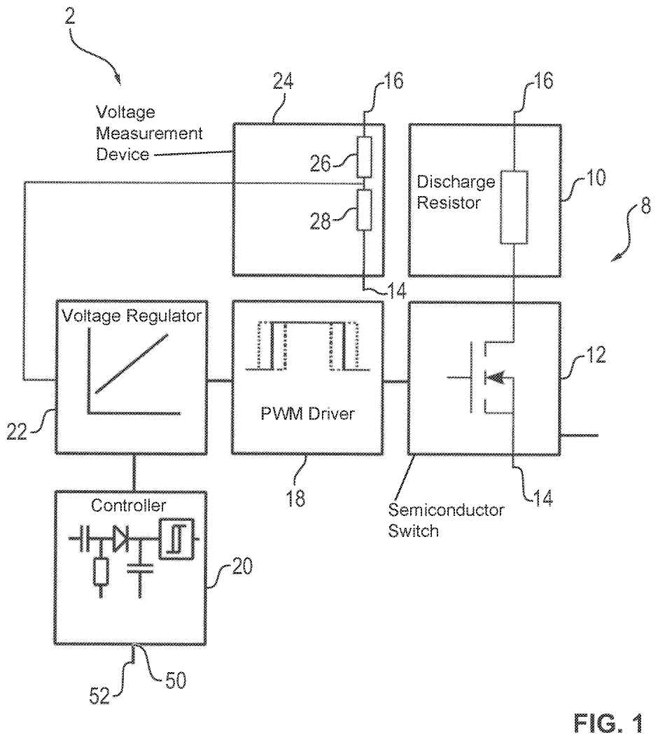

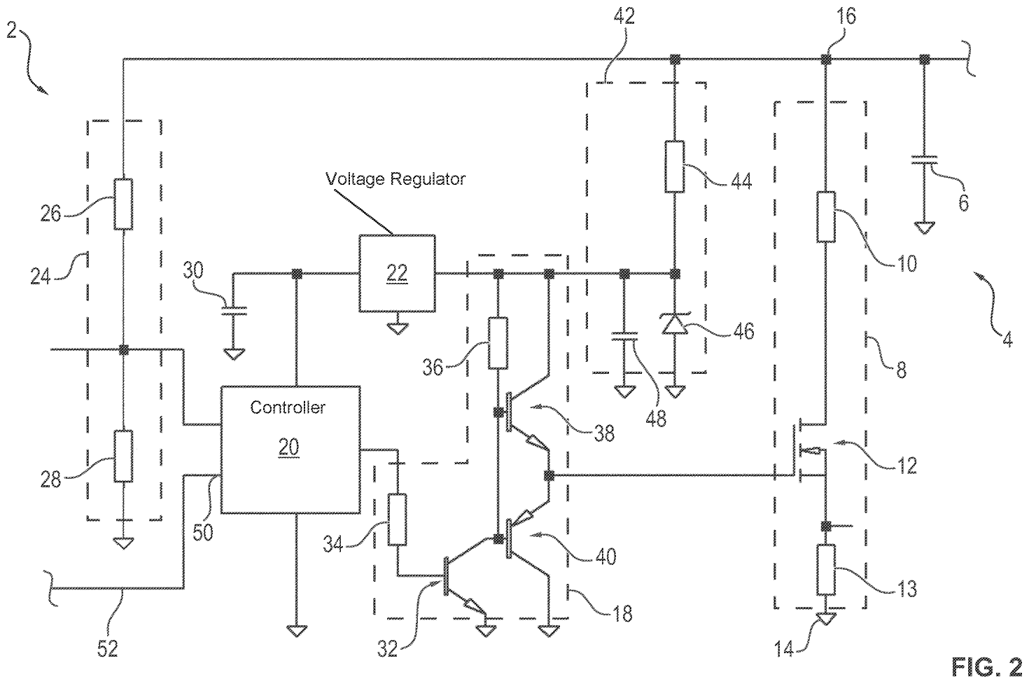

Referring now in detail to the figures of the drawings, in which mutually corresponding parts and variables are always provided with the same reference signs, and first, particularly, to FIG. 1 thereof, there is seen a discharge device 2 in a schematic and simplified illustration. The discharge device 2 is part of a high voltage system of an electrically powered unit 4, a detail of which is shown in FIG. 2. The unit 4 is for example realized as an electrical refrigerant drive of a motor vehicle air conditioning system. In this case, the unit 4 includes as components an electric motor, which is not shown in more detail, and an energy storage device, which is formed by a capacitor 6, for stabilizing an operating voltage value which is required for operating the electric motor.

The electrically powered unit 4 has the discharge device 2 in order to discharge the capacitor 6, if required. The discharge device 2 in turn has a discharge circuit 8 which is connected parallel to the capacitor 6 which is to be discharged.

In this case, the discharge circuit 8 has a series circuit of a discharge resistor 10 and a semiconductor switch 12 and a resistor 13. The semiconductor switch 12 is termed a discharge switch 12 in the following. In this case, the discharge switch 12 is realized as a normally-off MOSFET, which is led on the drain side to the discharge resistor 10 and on the source side to the resistor 13, which is connected to a reference potential 14, for example high voltage negative or a ground potential. The second connector of the discharge resistor 10 is contacted to an operating voltage (for example high voltage positive) 16 of the unit 4. The reference potential 14 and the operating voltage 16 are only provided with reference signs by way of example in the figures.

The discharge switch 12 is connected on the gate side to a pulse width modulation driver (PWM driver) 18, which is in turn activated by a controller 20 as dynamic signal detector. The controller 20 is for example realized as a microcontroller and is also designated as such in the following. A voltage regulator 22 or level converter (level shifter) for low powers is connected between the microcontroller 20 and the PWM driver 18, which is activated by the microcontroller 20 and which provides the pulse width for the PWM activation of the discharge switch 12 as a function of the current operating voltage 16. In order to detect the operating voltage 16, a (high voltage) voltage measurement device 24 is provided, which is coupled with the controller 20 and/or the voltage regulator 22.

The voltage measurement device 24 is for example realized as a voltage divider with two resistors 26, 28, which are connected in series and which are connected on one hand to the operating voltage 16 and on the other hand to the reference potential 14. The resistor 26 is in this case connected to the reference voltage 16 and the resistor 28 is connected to the reference potential 14, wherein a monitoring point, which is formed therebetween, is led to the microcontroller 20. Therefore, with regard to the capacitor 6 or the component of the unit 4, which is to be discharged, the voltage divider 24 effectively acts as a (passive) discharge resistor. The voltage divider 24 or the resistors 26, 28 are in this case dimensioned for a discharge time of the capacitor 6 of approximately 30 seconds for example.

A capacitor 30 is contacted between the microcontroller 20 and the voltage regulator 22 to stabilize the regulated voltage.

The PWM driver 18 has an emitter circuit, which is connected to the microcontroller 20, having a semiconductor switch 32, which is realized as a bipolar junction transistor, and having a (base) series resistor 34, which is connected between the base and the microcontroller 20, and having a collector resistor 36, wherein the bipolar junction transistor 32 is led on the emitter side to the reference potential 14. The PWM driver 18 furthermore has an output stage having a half bridge with two complementary semiconductor switches 38, 40. The semiconductor switches 38, 40 are realized as bipolar junction transistors, wherein the semiconductor switch 38 is an NPN bipolar junction transistor in particular and the semiconductor switch 40 is a PNP bipolar junction transistor in particular.

The gate terminal of the discharge switch 12 is connected between the emitter of the semiconductor switch 38 and the emitter of the semiconductor switch 40. The collector of the semiconductor switch 40 is led to the reference potential 14, wherein the collector of the semiconductor switch 38 is connected together with the collector resistor 36 to the output of the voltage regulator 22.

The collector of the semiconductor switch 40 and the collector of the semiconductor switch 38 are furthermore coupled with a (supply) circuit 42. The circuit 42 has a series circuit of a resistor 44 and a Zener diode 46, wherein the resistor 44 is connected to the operating voltage and the anode of the Zener diode 46 is connected to the reference potential 14. The collector of the semiconductor switch 40 and the collector of the semiconductor switch 38 are in this case connected between the resistor 44 and the Zener diode 46, wherein a capacitor 48 is connected to the reference potential 14 parallel to the Zener diode 46.

In this case, the Zener diode 46 prevents the PWM activation/control voltage at the gate terminal of the discharge switch 12 from exceeding a permitted maximum value, wherein the capacitor 48 is used for voltage stabilization of the PWM voltage generated by the PWM driver 18.

Operation of the discharge device 2 according to the method is described in more detail in the following.

During the operation of the unit 4, the applied high voltage or operating voltage 16 charges the capacitor 6 to a high voltage level, which may be a danger to health or life if touched. In order to reduce the danger as required, it is necessary to discharge the capacitor 6 as fast as possible. This discharge takes place via the load or discharge resistor 10 of the discharge circuit 8, which is switched on as a load by the fast discharge switch 12.

In order to achieve short discharge times, but generate little power loss during long-term operation, the discharge switch 12 is controlled by the microcontroller 20 in such a way that the discharge circuit 8 is inactive during normal operation. To this end, the controller 20 has a disable input 50 for a disable signal 52. If the disable signal 52 is supplied or is applied, the disable input 50 is activated and consequently shuts down the discharge circuit 8.

The disable input 50 is monitored by the microcontroller 20 as to whether it is turned on and off at regular time intervals. If this alternating signal fails or there is a fault with the same, the discharge circuit 8 is activated. This means that the microcontroller 20 turns on the discharge switch 12 by using the PWM driver 18 and the discharge circuit 8 therefore transitions from a rest mode to a discharge mode if no disable signal 52 is supplied to the disable input 50.

According to the invention, the pulse width of the (PWM) discharge signal is controlled in this case by the microcontroller 20 using the voltage regulator 22, which enables a fast discharge with low power loss in that the current voltage is provided by using the voltage measurement device 24. The pulse width of the discharge current through the discharge resistor 10 is controlled in such a manner as a function of the current operating voltage 16 that a decreasing voltage causes a larger pulse width of the discharge signal generated by the PWM driver 18.

The relationship between the current voltage and the pulse width is ideally dimensioned in such a way that for every voltage, the same power is converted on average in the discharge resistor 10.

The discharge can be commanded by the disable input 50: During an activation of the discharge due to absence of the disable signal 52, the output voltage at the resistor 13 is measured, in order to monitor the correct function of the discharge circuit 8.

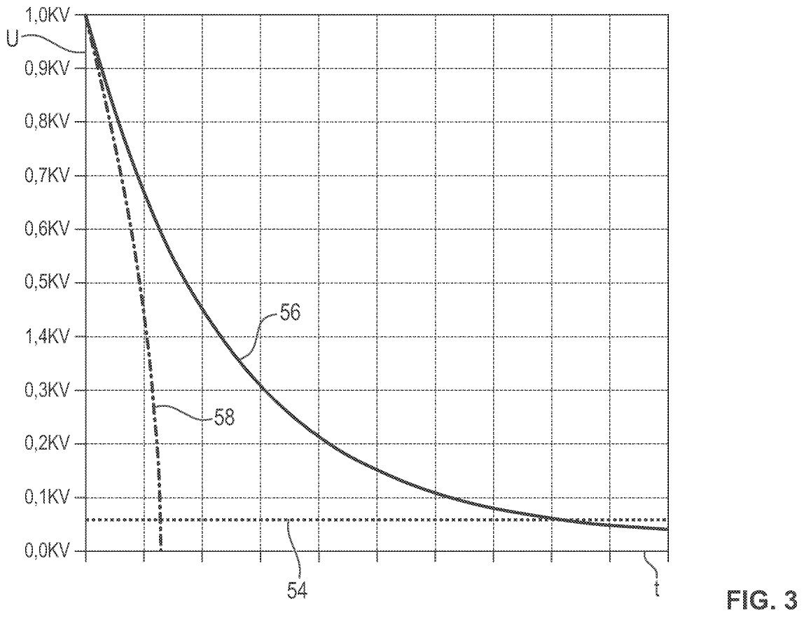

In the schematic time-voltage graph of FIG. 3, the time t is plotted horizontally, that is to say along the abscissa axis (x axis) and a voltage U is plotted, for example in kilovolts (kV) along the vertical ordinate axis (y axis). Three voltage curves 54, 56 and 58 for a discharge process of the previously described discharge device 2 are shown in the graph.

The voltage curve 54 is illustrated as a dotted line and has a constant horizontal shape parallel to the time axis t. In this case, the voltage curve 54 corresponds to a safe discharge voltage, that is to say an operationally safe voltage level, of the capacitor 6, which is 60 V for example.

The voltage curve 56 shows a conventional RC discharge, that is to say a discharge of a capacitor via an ohmic resistor, whereas the voltage curve 58, which is shown as a dot-dashed line, shows the PWM-controlled discharge of the capacitor 6 with a constant power according to the invention. As can be clearly seen comparatively in FIG. 3, the safe voltage level 54 is reached substantially faster by using the discharge device 2 according to the invention than by using a conventional RC discharge.

The invention is not limited to the previously described exemplary embodiments. Rather, different variants of the invention may also be deduced therefrom by a person skilled in the art without departing from the subject matter of the invention. In particular, all of the individual features described in connection with the exemplary embodiments can also be combined with one another in a different way without departing from the subject matter of the invention.

The following is a summary list of reference numerals and the corresponding structure used in the above description of the invention.

### LIST OF REFERENCE SIGNS

2 Discharge device
4 Unit
6 Capacitor
8 Discharge circuit
10 Discharge resistor
12 Semiconductor switch/discharge switch
13 Resistor
14 Reference potential
16 Operating voltage
18 Pulse width modulation driver
20 Microcontroller
22 Voltage regulator
24 Voltage measurement device/voltage divider
26 Resistor
28 Resistor
30 Capacitor
32 Semiconductor switch/bipolar junction transistor
34 Series resistor
36 Collector resistor
38 Semiconductor switch/bipolar junction transistor
40 Semiconductor switch/bipolar junction transistor
42 Circuit
44 Resistor
46 Zener diode
48 Capacitor
50 Disable input
52 Disable signal
54 Voltage curve
56 Voltage curve
58 Voltage curve
U Voltage
t Time

1. A discharge device for discharging an electrical system or an electrically powered unit, the discharge device comprising:
a discharge circuit having a discharge resistor and a normally-off first semiconductor switch connected in series with said discharge resistor; and
a controller for activating said first semiconductor switch;
said controller being commanded to deactivate said discharge circuit during normal operation of the electrical system or the unit, and to activate said discharge circuit in an event of an absence of commanding.

2. The discharge device according to claim 1, wherein:
said controller is configured as a commanding device and has a disable input for receiving a disable signal; and
said controller turns on said first semiconductor switch when no disable signal is applied at said disable input.

3. The discharge device according to claim 1, wherein said first semiconductor switch has a control input, and a pulse width modulation driver is disposed between said controller and said control input of said first semiconductor switch for a pulse-width-modulated activation of said first semiconductor switch.

4. The discharge device according to claim 3, which further comprises an output stage having two complementary second semiconductor switches, said pulse width modulation driver having an emitter circuit connected to said controller and activating said output stage.

5. The discharge device according to claim 4, which further comprises a voltage divider, said controller detecting a voltage of the electrical system or the unit by using said voltage divider.

6. The discharge device according to claim 5, wherein a pulse width of the pulse-width-modulated activation of said first semiconductor switch is controlled as a function of a current voltage of the electrical system or the unit.

7. The discharge device according to claim 6, which further comprises a voltage regulator connected between said controller and said pulse width modulation driver, said voltage regulator adjusting the pulse width of the pulse-width-modulated activation as a function of the current voltage of the electrical system or the unit.

8. The discharge device according to claim 6, wherein the pulse-width-modulated activation is controlled by enlarging the pulse width with a decreasing voltage of the electrical system or the unit.

9. The discharge device according to claim 1, wherein said discharge circuit has a resistor connected in series with said discharge resistor and said first semiconductor switch, said controller monitoring an output voltage of said resistor in the event of the absence of the commanding.

10. An electrically powered unit or an electric refrigerant compressor of a motor vehicle, the electrically powered unit or the electric refrigerant compressor comprising the discharge device according to claim 1.

11. A discharge method for discharging an electrical system or an electrically powered unit, the method comprising:
using the discharge device according to claim 1 to discharge the electrical system or the electrically powered unit; and
turning on said first semiconductor switch if no disable signal is supplied to the disable input.
